(19) United States
(12) Patent Application Publication
(10) Pub. No.: US 2026/0241928 A1
(43) Pub. Date: Aug. 20, 2026

(54) Free Space Detection Device, Object Position Normalization Method

(71) Applicant: Hitachi Astemo, Ltd., Hitachinaka-shi, Ibaraki (JP)

(72) Inventors: Hitoshi HAYAKAWA, Tokyo (JP); Shigenori HAYASE, Hitachinaka-shi, Ibaraki (JP)

(21) Appl. No.: 18/995,304

(22) PCT Filed: Jul. 14, 2023
(86) PCT No.: PCT/JP2023/026078

§ 371 Date: Jan. 16, 2025

(30) Foreign Application Priority Data
Aug. 10, 2022 (JP) 2022-128204

(51) Int. Cl. B60W 30/095; B60W 40/02; G06T 7/11

(52) U.S. Cl. CPC B60W 30/095; B60W 40/02; G06T 7/11; G06T 2207/30252

(57) ABSTRACT

A free space detection device arranges free space end points, which are determined based on detection points of an object detected around a predetermined center point, on a plurality of reference lines radially extending from the center point, and extracts an outer edge of a free space by connecting the free space end points on the plurality of reference lines. The free space detection device is configured to set a boundary line between the reference lines adjacent to each other, and when one of the reference lines is referred to as a first reference line, two of the boundary lines sandwiching the first reference line are referred to as first boundary lines, and a region sandwiched between the first boundary lines with the first reference line being a center is referred to as a first angle region, the free space detection device is configured to determine a position of the free space end point on the first reference line based on a position closest to the center point among in-region detection points which are the detection points present in the first angle region.

### TECHNICAL FIELD

The present invention relates to a free space detection device and an object position normalization method.

### BACKGROUND ART

With the aim of ensuring safety and improving comfort in an automobile, there are vehicles equipped with driving support functions and autonomous driving functions which monitor the surroundings and perform some driving actions on behalf of humans. In order to achieve the driving support functions and the autonomous driving functions, it is necessary to detect a free space which is a travelable region around a host vehicle in order to understand a surrounding situation of the host vehicle, and execute driving action determination such as speed reduction based on a detection result. The detection of the free space around the host vehicle is performed by detecting relative positions of obstacles viewed from the host vehicle using sensors such as cameras, radars, light detection and ranging s (LIDARs), or sonars mounted in the vehicle, and by detecting a region where there is no obstacle viewed from the host vehicle. The driving action determination is executed by computer software that receives inputs such as human operations, detection results by the sensors, and that outputs, to the vehicle, target speeds, target positions, or control instructions such as acceleration and deceleration or steering.

The software that executes the driving action determination is created for each of the driving support functions and the autonomous driving functions such as lane keeping support, preceding vehicle following, and emergency braking, and a plurality of functions are harmonized in the entire vehicle. An output form, that is, a format of a detection result of the sensor, is different for each sensor depending on an operation principle and economical and technical restrictions, and the output format may be different when a vehicle type or age is different. On the other hand, to prepare software for executing the driving action determination for each of the driving support functions and the autonomous driving functions dedicated for a combination of different sensors for each vehicle type is not efficient, since the number of combinations is large. Therefore, it is desirable that a detection result of a sensor is represented in a common format, software that executes the driving action determination is created based on the common format, and then a difference in a vehicle type can be adjusted by parameter setting and so on.

As a representation of a detection result of a sensor, there is a polar coordinate representation in which position of obstacles, that is, a boundary of a free space is represented in two dimensions in order for a host vehicle to move on a road plane, and is represented by directions and distances viewed from the host vehicle. When position of obstacles around the host vehicle represented by polar coordinates represented in a common format, the representation of the position of the obstacles by distances at any angle or direction will increase information amount to be handled and a processing load will be increased. Therefore, the entire circumference of the host vehicle is divided into fixed angles, and the free space is represented as distances to obstacles in each division direction. However, since a division angle in a common format does not always coincide with an angle detected by a sensor, a detection position represented by polar coordinates using any angle detected by the sensor needs to be converted into a representation of a distance in each of the division direction in the common format.

PTL 1 discloses an information processing device including a processing unit that calculates, for each of a plurality of sensors having different characteristics, a first presence probability of an object present around a moving object by using position information of the object measured by the sensor, acquires, for each of the plurality of sensors, non-measurement information indicating that the position information is not obtained, and determines a second presence probability of the object based on the first presence probability and the non-measurement information.

### CITATION LIST

### Patent Literature

PTL 1: JP2017-215939A

### SUMMARY OF INVENTION

### Technical Problem

The invention disclosed in PTL 1 cannot accurately set distances to the position of detected obstacles.

### Solution to Problem

A free space detection device according to a first aspect of the invention is a free space detection device that arranges free space end points, which are determined based on detection points of objects detected around a predetermined center point, on a plurality of reference lines radially extending from the center point, and that extracts an outer edge of a free space by connecting the free space end points on the plurality of reference lines, the free space detection device is configured to: set a boundary line between the reference lines adjacent to each other; and when one of the reference lines is referred to as a first reference line, two of the boundary lines sandwiching the first reference line are referred to as first boundary lines, and a region sandwiched between the first boundary lines with the first reference line being a center is referred to as a first angle region, the free space detection device is configured to determine a position of the free space end point on the first reference line based on a position closest to the center point among in-region detection points which are the detection points present in the first angle region.

An object position normalization method according to a second aspect of the invention is executed by a free space detection device that arranges free space end points, which are determined based on detection points of objects detected around a predetermined center point, on a plurality of reference lines radially extending from the center point, and that extracts an outer edge of a free space by connecting the free space end points on the plurality of reference lines. The object position normalization method includes: when a boundary line between the reference lines adjacent to each other is set, one of the reference lines is referred to as a first reference line, two of the boundary lines sandwiching the first reference line are referred to as first boundary lines, and a region sandwiched between the first boundary lines with the first reference line being a center is referred to as a first angle region, determining a position of the free space end point on the first reference line based on a position closest to the center point among in-region detection points which are the detection points present in the first angle region.

### Advantageous Effects of Invention

According to the invention, a free space can be set with a high accuracy.

### BRIEF DESCRIPTION OF DRAWINGS

FIG. 1 is a hardware structure diagram showing a vehicle equipped with a free space detection device according to a first embodiment.

FIG. 2 is a functional block diagram showing the free space detection device according to the first embodiment.

FIG. 3 is a flowchart showing processing of a normalization unit according to the first embodiment.

FIG. 4 is a diagram showing an example of an obstacle information array.

FIG. 5 is a flowchart showing details of step S306 in FIG. 3.

FIG. 6 is a view showing a specific example of the processing shown in FIG. 5.

FIG. 7 is a hardware structure diagram showing the free space detection device.

FIG. 8 is a flowchart showing processing of a normalization unit according to a second embodiment.

FIG. 9 is a flowchart showing details of step S306 in FIG. 8.

FIG. 10 is a view showing a specific example of the processing shown in FIG. 9.

FIG. 11 is a view showing a comparison between a method according to the second embodiment and a method according to the first embodiment.

FIG. 12 is a view showing a comparison between the method according to the second embodiment and a method according to a second comparative example.

FIG. 13 is a view showing a comparison between the method according to the second embodiment and the method according to the second comparative example.

FIG. 14 is a view showing a comparison between the method according to the second embodiment and the method according to the second comparative example.

FIG. 15 is a hardware structure diagram showing a vehicle equipped with a free space detection device according to a third embodiment.

FIG. 16 is a functional block diagram showing the free space detection device according to the third embodiment.

FIG. 17 is a flowchart showing processing of a normalization unit according to a fourth embodiment.

FIG. 18 is a view showing a specific example of the processing of the normalization unit according to the fourth embodiment.

### DESCRIPTION OF EMBODIMENTS

### First Embodiment

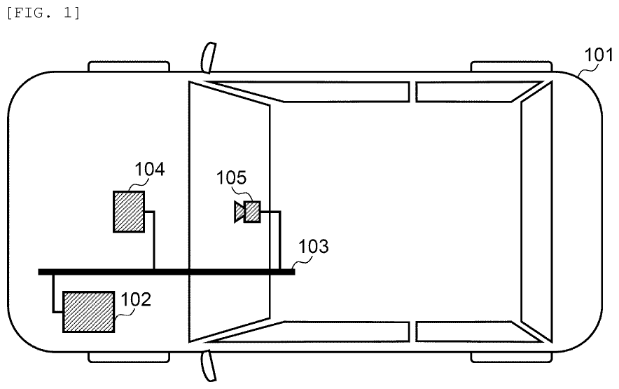

Hereinafter, a first embodiment of a free space detection device will be described with reference to FIGS. 1 to 7. In the present embodiment, in a vehicle, a configuration and an operation of a free space detection device mounted on a vehicle system that detects a situation of the host vehicle and controls the vehicle will be described. The control of the vehicle includes indirect control that presents information to a driver, and the vehicle system does not necessarily have to achieve an autonomous driving function that enables the vehicle to operate autonomously. For example, the vehicle system may be a vehicle system having a driving support function that transmits information on a free space to a driver by voice, an image, or the like.

FIG. 1 is a hardware structure diagram showing a vehicle 101 equipped with a free space detection device 102. In FIG. 1, hardware that is less relevant to the free space detection device 102 is omitted. Hereinafter, the vehicle 101 may be referred to as the “host vehicle” or the “own vehicle” in order to distinguish the vehicle 101 from other vehicles. The vehicle 101 includes the free space detection device 102, a common bus 103, a driving action planning device 104, and a camera sensor 105. The free space detection device 102, the driving action planning device 104, and the camera sensor 105 are connected by the common bus 103 and can transmit information to one another.

The camera sensor 105 is an obstacle detection sensor that images surroundings of the vehicle 101 and detects obstacle from the captured image. When the camera sensor 105 detects obstacles from the captured image, the camera sensor 105 estimates positions of detection points of the obstacles with reference to the host vehicle 101. The estimation of the positions of the detection points can be implemented by, for example, projecting obstacle positions on a road surface by an image recognition technique and road surface estimation, and may be implemented by other methods. For example, a plurality of imaging elements may be prepared, and the position of the detection point may be estimated by distance measurement according to a stereo vision technique, or the position of the detection point may be estimated by measuring a distance by combining with another sensor such as a radar to increase accuracy.

Further, although a name “camera” is given for the sake of convenience, it is not essential to provide an imaging element, and the camera sensor 105 may include a processing system and a sensor capable of detecting obstacles. For example, the camera sensor 105 may perform detection at night by using a radar sensor, or may detect obstacle positions with high accuracy by using a light detection and ranging (LIDAR) sensor.

In addition, an object to be detected by the camera sensor 105 does not necessarily have to be an obstacle with a physical form. For example, the object to be detected may be an end point close to the host vehicle in a region where the presence of a vehicle is estimated by a headlight, a shadow, a sound, or the like, or a region where it is determined that entry of the own vehicle is undesirable based on a predicted obstacle movement result, a traffic rule, or the like. By using a representation other than an actual position of obstacles, it is possible to increase the number of events that can be handled, such as a risk that cannot be directly detected by a sensor or prediction of a future event.

The free space detection device 102 detects a free space to be described later by using information on a detection point detected by the camera sensor 105, and passes free space information to the driving action planning device 104. The driving action planning device 104 determines an action to be taken by the host vehicle using the free space information, and controls the vehicle according to the determined action. The free space detection device 102 and the driving action planning device 104 are each an electronic control unit (ECU), receive information from the common bus 103, process the information by software, and transmit a processing result to the common bus 103. Each ECU executes software stored in a storage device by a central processing unit, and transmits and receives information to and from the common bus 103 using an input and output device.

A method of implementing functions of the free space detection device 102 and the driving action planning device 104 is not limited to the ECU. For example, costs may be reduced by using an inexpensive computer represented by a single-board computer. The driving action planning device 104 may acquire information from the common bus 103 and the driving action planning device 104 may directly control the vehicle 101 without outputting a processing result to the common bus 103.

A method for directly controlling the vehicle 101 by the driving action planning device 104 is not particularly limited. For example, the driving action planning device 104 may indirectly control the vehicle by converting information on a target speed or steering into a sound or the like and transmitting the sound or the like to a driver, or may directly convert the information into a target hydraulic pressure or the like for machine control and instruct an accelerator, a brake, a steering, or the like. Since a method for controlling the vehicle 101 by the driving action planning device 104 is common, detailed description thereof is omitted. Processing contents of the driving action planning device 104 are not the focus of the invention, and are a general technique used in following a preceding vehicle, emergency braking, and the like, and thus detailed description thereof is omitted.

The common bus 103 is a communication bus that can transmit at least information output from the camera sensor 105 to the free space detection device 102 and can transmit information output from the free space detection device 102 to the driving action planning device 104. The common bus 103 may be, for example, a bus type communication bus such as a controller area network (CAN) or a star type communication bus such as IEEE 802.3.

The free space detection device 102, the driving action planning device 104, and the camera sensor 105 do not need to be divided as hardware. For example, functions of the free space detection device 102 and the driving action planning device 104 may be executed by a central processing unit inside the camera sensor 105, and only the camera sensor 105 may be configured as a device to save an installation space. In this case, a function of the common bus 103 is implemented by a memory copy in the central processing unit.

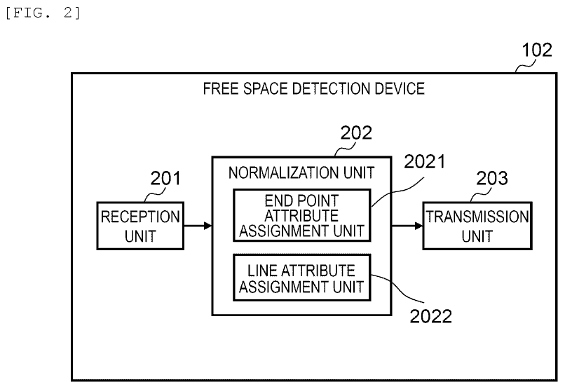

FIG. 2 is a functional block diagram showing the free space detection device 102. The free space detection device 102 includes a reception unit 201, a normalization unit 202, and a transmission unit 203 as functions. The reception unit 201 takes a detection result of obstacles detected by the camera sensor 105, which is obtained from the camera sensor 105 via the common bus 103, into the free space detection device 102, and outputs the detection result to the normalization unit 202. The normalization unit 202 converts the detection result of the obstacle into a common format as a free space and outputs free space information to the transmission unit 203. In the present embodiment, the conversion of obstacle information into a common format as a free space is referred to as normalization. An information transmission block transmits the free space information converted into the common format by the normalization unit 202 to the driving action planning device 104 via the common bus 103.

The normalization unit 202 may include an end point attribute assignment unit 2021 and a line attribute assignment unit 2022 as shown in FIG. 2. However, the end point attribute assignment unit 2021 and the line attribute assignment unit 2022 are preliminary configurations, and the normalization unit 202 may not include at least one of the end point attribute assignment unit 2021 and the line attribute assignment unit 2022. The end point attribute assignment unit 2021 assigns an object attribute to normalized obstacle position information. The line attribute assignment unit 2022 assigns an attribute to a line connecting normalized obstacle positions. The attribute is at least information indicating the presence or absence of each obstacle, and when an obstacle is present, the attribute may be information capable of identifying whether the obstacle is a moving object or a stationary object. Further, at least one of a speed and an acceleration of the obstacle may be included in the attribute.

Since each functional block included in the free space detection device 102 is implemented as a function by software, a plurality of blocks may be integrated into one block. For example, the reception unit 201, the normalization unit 202, and the transmission unit 203 may be implemented as one functional block to reduce overhead associated with information transmission between blocks. Various methods can be used for information transmission between functional blocks. For example, the information may be transmitted by storing the information in a shared memory, or the functional blocks may be arranged in different cores or devices, and the functional blocks may be connected to one another through a communication path such as serial communication to transmit the information, so that each device has a simple configuration.

The common format adopted by the normalization unit 202 is a distance to obstacles in each direction obtained by dividing the entire circumference of the vehicle 101 at a predetermined step angle, that is, at a reference angle. For example, when the step angle is “0.1 degrees”, the front of the vehicle 101 is set to 0 degrees, reference angles different by 0.1 degrees in a clockwise direction, that is, 3600 reference angles from 0 degrees to 359.9 degrees, are defined, and a distance to a position where the obstacle is present is set for each reference angle. In this case, a center point may be the center of the vehicle 101 or another position. Hereinafter, the center point is also referred to as an “original point”. Since there is a possibility that no obstacle is present, a direction in which no obstacle is detected is set to a value indicating that there is no obstacle, for example, a negative value.

Hereinafter, each point defined by the angle and the distance described above is referred to as a “free space end point”. A region obtained by connecting free space end points indicating that there is an obstacle indicates an outer edge of a free space, and indicates that the host vehicle 101 can travel in the free space. Hereinafter, a straight line passing through the original point and indicating a reference angle is also referred to as a “reference line”. Therefore, a common format in the present embodiment can also be regarded as position information of the free space end point arranged on the reference line. Every reference line has one end at the original point. for example, a first reference line is a half straight line that is directed toward the front in a traveling direction of the vehicle 101 at 0 degrees, and a second reference line is a half straight line that passes through the original point, is on a left side of the first reference line, and has a step angle formed between the second reference line and the first reference line.

It is ideal that a free space completely matches a region where there is no obstacle. It is allowed that a free space is represented narrower than the ideal free space, and it is allowed that a gap is present between the free space and an obstacle. However, it is not allowed that a free space is represented wider than the ideal free space, and it is not allowed that a free space is recognized as a free space even though there is an obstacle. This is because, when the driving action planning device 104 uses such free space information, the vehicle 101 may collide with the obstacle.

In the present embodiment, an index of appropriateness of a free space is referred to as “accuracy”. For example, when a free space includes a region where there is an obstacle, the accuracy of the free space is very low. When a free space does not include a region where there is an obstacle at all, it can be said that the accuracy is higher as a distance between the free space and the obstacle, that is, a gap region is smaller.

The common format representing the free space described here is a specific example in the present embodiment, and other definitions may be used. For example, an angle other than the front of the vehicle 101 may be set to 0 degrees, or the step angle may be changed. For example, the step angle does not have to be constant over the entire range, and for example, different step angles may be set for the front and the rear of the vehicle 101. That is, an angle between the reference lines may not be a constant value. In this case, it is preferable to set a front step angle having a high collision risk to be small and set a rear step angle to be large. With such setting, a data size is reduced and a processing load is reduced. Further, instead of setting an attribute value to a point, the processing load may be reduced by setting an attribute value to a line connecting contiguous points in an angle direction and omitting contiguous points having the same attribute.

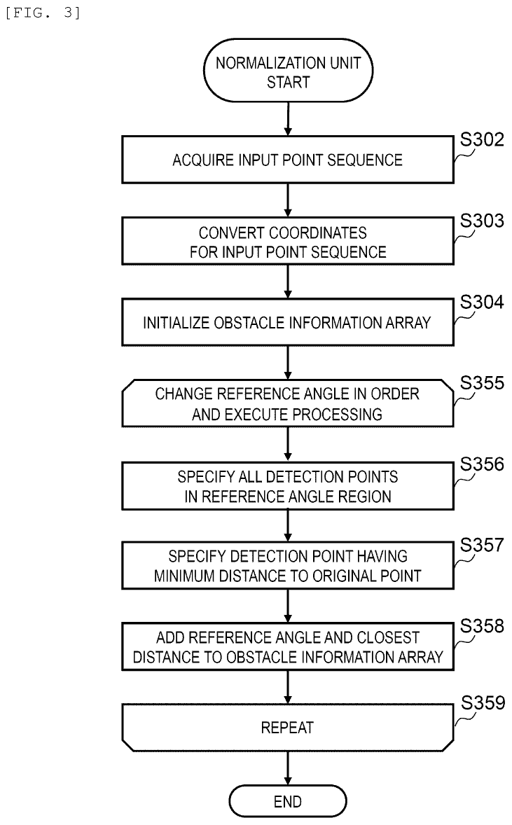

FIG. 3 is a flowchart showing processing of the normalization unit 202. In FIG. 3, description of processing of the end point attribute assignment unit 2021 and the line attribute assignment unit 2022 is omitted. First, in step S302, the normalization unit 202 acquires detection point information output by the camera sensor 105. There may be only one detection point, but since there are often a plurality of detection points, hereinafter, the plurality of detection points are referred to as an “input point sequence”. The input point sequence, which is a processing result of step S302, is represented as an array of positions that are obstacle detection points as viewed from the vehicle 101, that is, a point sequence. For example, the obstacle position is represented as two-dimensional coordinates on an orthogonal coordinate system in which the center of the vehicle 101 is the original point, the front of the vehicle 101 is a positive x axis, and the left of the vehicle 101 is a positive y axis. Alternatively, three-dimensional coordinates may be adopted to add information in a height direction so that a collision risk with the host vehicle can be determined more accurately.

In subsequent step S303, the normalization unit 202 performs polar coordinate conversion on each detection point constituting the input point sequence. The center of a polar coordinate system is, for example, the center of the vehicle 101. In subsequent step S304, the normalization unit 202 initializes an obstacle information array that stores obstacle information. In subsequent step S355, the normalization unit 202 changes reference angles to be processed in order and repeats processing in steps S356 to S358. Specifically, the normalization unit 202 calculates all reference angles, stores the calculated reference angles in an array in an ascending order, and increases array indexes in order to change processing targets in order.

In the present embodiment, a processing range of the input point sequence is limited by setting the reference angles in an ascending order to save processing, but the processing may be simplified without setting the reference angles in the ascending order. Since the reference angle, the reference line, and a reference angle region to be described later have a correspondence relationship of 1:1:1, it can be said that the reference lines to be processed and the reference angle regions to be processed are changed in order and the processing in steps S356 to S358 are repeated.

The reference angle region is a region whose boundary is center lines between a reference line corresponding to a reference angle to be processed and adjacent reference lines on a right side and a left side. For example, when the step angle is 0.1 degrees, a region of −0.05 degrees or more and less than +0.05 degrees from the reference angle to be processed is the reference angle region. In the present embodiment, a center line between reference angles adjacent to the center line is set as the boundary, but it does not necessarily have to be the center line. For example, a region in front of the host vehicle may be widened to detect obstacles close to the front side of the host vehicle, and an obstacle having a high risk of colliding with the host vehicle may be emphasized, which makes it easier to make a safer collision determination.

In step S356, the normalization unit 202 specifies all detection points present in the reference angle region to be processed. For example, when the reference angle to be processed is “12.5 degrees” and the step angle is “0.1 degrees”, detection points whose angles are “12.45 degrees” or more and less than “12.55 degrees” are listed. In subsequent step S357, the normalization unit 202 specifies a detection point having a minimum distance to the original point among the detection points specified in step S356. Hereinafter, a distance to the original point of the detection point specified in this step is referred to as a “closest distance”. In other words, a distance between the original point and a detection point closest to the original point among detection points present in the reference angle region is the closest distance.

In subsequent step S358, the normalization unit 202 adds a combination of the reference angle targeted in step S305 and the closest distance obtained in step S307 to the obstacle information array initialized in step S304. This is information indicating a position of a free space end point on a reference line. When a value indicating that the closest distance is not obtained is set in step S307, the information is converted into information indicating that there is no obstacle in step S308, and then the information is added to the obstacle information array. In step S309, the normalization unit 202 changes the processing target and returns the processing to step S306 when it is determined that there is an unprocessed reference angle, and ends the processing shown in FIG. 3 when the processing in steps S306 to S308 are executed for all reference angles to be processed.

When the processing of the normalization block shown in FIG. 3 is completed, all reference angles, that is, the closest distances corresponding to all reference lines are stored in the obstacle information array initialized in step S304. In the initialization of step S304, information indicating that the closest distance is not obtained in step S307 may be set in advance, and when the closest distance is not obtained in step S307, a processing time of step S308 may be saved by skipping the processing in step S308.

The end point attribute assignment unit 2021 assigns an attribute to each point included in the obstacle information array. For example, the end point attribute assignment unit 2021 may determine that there is no obstacle when the closest distance is larger than a predetermined threshold. The end point attribute assignment unit 2021 may distinguish between a stationary object and a moving object depending on whether a value of each point included in the obstacle information array changes in time series, or may set an attribute with reference to additional information received by the reception unit 201, for example, information indicating an obstacle type. The line attribute assignment unit 2022 assigns an attribute to a line based on attributes of points at both ends of the line. For example, when at least one of the points at both ends of a line changes in time series, the line attribute assignment unit 2022 may determine that the line indicates a moving object, and when both points of a line have the attribute of a stationary object, the line attribute assignment unit 2022 may assign an attribute of a stationary object to the line.

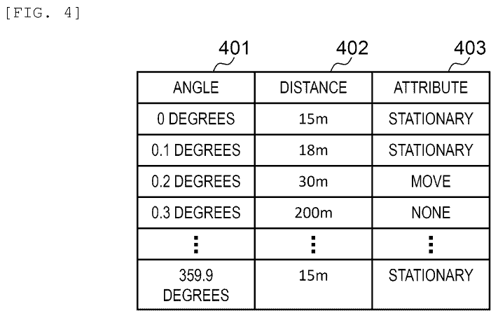

FIG. 4 is a diagram showing an example of the obstacle information array. Elements of the array include an angle 401, a distance 402, and an attribute 403. The reference angles to be processed in steps S305 to S309 are stored in order in the angle 401, the closest distance calculated in step S308 is stored in the distance 402, and whether the closest distance is obtained in step S307 is set in the attribute 403. The attribute 403 is set to “stationary” or “move” according to information held by an original input point sequence, and is set to “none” when the closest distance is not obtained in step S307. When the original input point sequence does not have information in particular, the attribute 403 is set to “move”.

By setting the presence or absence of an obstacle and the presence or absence of movement in the attribute 403, the presence or absence of a possibility that a shape of a free space changes is represented, and is used as reference information in the case of making a driving action plan based on the free space information. Instead of determining movement or stationary in the attribute 403, the presence or absence of an obstacle may be simply set to simply write processing or information. Further, a distance may be set to 0 or more when there is an obstacle, and a negative distance may be set in the distance 402 when there is no obstacle, thereby omitting the attribute 403 and saving a memory and a communication band.

In this case, a value equal to or larger than a sensor detection distance may be set instead of using a negative value as a value indicating that there is no obstacle. The setting may be changed appropriately to cope with a limitation of a programming language to be used. For example, when a negative value cannot be handled in a programming language to be used, or in a specific variable type, “0” may be used instead of the negative value. Further, when the reference angle is designed in advance, since the reference angle can be calculated from an array number, the angle 401 may be omitted to save a memory and a communication band. In any case, in step S308, the information used in the driving action planning device 104 is set to the obstacle information array.

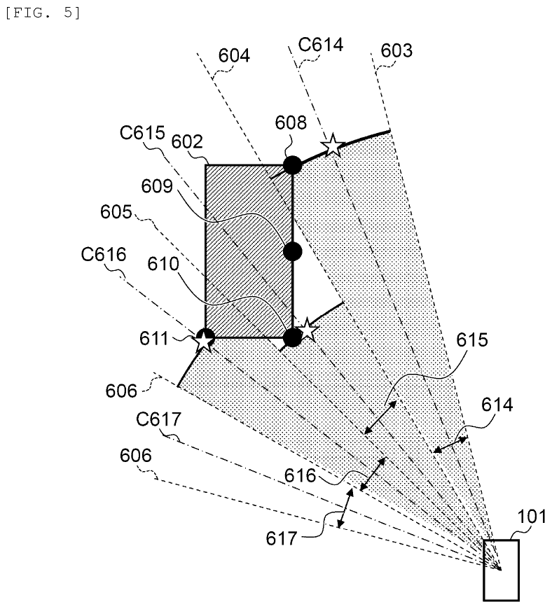

FIG. 5 is a diagram showing a method for converting to a common format according to the present embodiment. In FIG. 5, the center of the vehicle 101 is represented as the original point, and detection points at which a sensor detects an obstacle 602 are indicated by black circles denoted by reference numerals 608, 609, 610, and 611. The original point is not limited to the center of the vehicle 101, and may be, for example, the center of a rear wheel axle of the vehicle 101 to facilitate motion calculation of the vehicle. Since the obstacle 602 is large, the obstacle 602 is detected at a plurality of detection points as indicated by the reference numerals 608 to 611.

In FIG. 5, four reference lines C614 to C617 are indicated by dash-dotted lines, and center lines 603 to 606 of the reference lines are indicated by broken lines. Regions 614 to 617 which are centered on the respective reference lines and sandwiched by the center lines are reference angle regions. A white star present on each reference line represents a free space end point.

In the method according to the present embodiment, a distance to a detection point closest to the vehicle 101 in each reference angle region is set as a closest distance of the region. That is, a distance to the detection point 608 is the closest distance in the region 614, a distance to the detection point 610 is the closest distance in the region 615, and a distance to the detection point 611 is the closest distance in the region 616. Therefore, a position indicated by the white star in FIG. 5 is a free space end point. It can also be said that the free space end point indicated by the white star according to the present embodiment is moved on an arc centered on the original point and is arranged at a position intersecting the reference line, the arc being points closest to the original point in a partial point sequence in the respective reference angle regions. The region 617 is set to a negative value since there is no detection point. In FIG. 5, an outer edge of a free space region obtained by the method according to the present embodiment is indicated by an arc of a solid line.

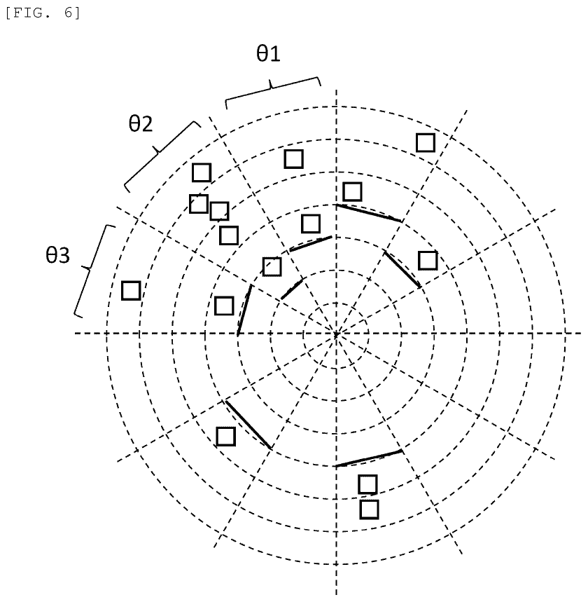

FIG. 6 is a diagram showing a method according to a comparative example. In the comparative example shown in FIG. 6, not only an angle but also a distance is divided at predetermined intervals to form a grid, and a region closer to the original point than a grid of an obstacle closest to the original point is set as a free space region for each angle region. In FIG. 6, an obstacle detected by a sensor is indicated by a white square, and a boundary of a free space for each angle region is indicated by a solid line. For example, in an angle region θ1, since there are obstacles in a fourth grid and a sixth grid from the center, a region closer to the original point than the fourth grid closest to the center, that is, a grid from the center to a third grid is a free space. In an angle region θ2, there are obstacles between a third grid and a fourth grid from the center and in fifth to seventh grids. In this case, a region closer to the original point than the third grid closest to the center, that is, a grid from the center to a second grid is a free space. In this comparative example, since not only an angle of the free space but also a distance to the original point has discrete values, accuracy is lower than that in the present embodiment.

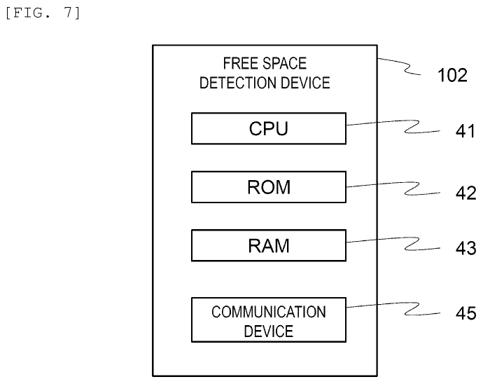

FIG. 7 is a hardware structure diagram showing the free space detection device 102. The free space detection device 102 includes a CPU 41 which is a central processing unit, a ROM 42 which is a read only storage device, a RAM 43 which is a readable and writable storage device, and a communication device 45. The CPU 41 loads a program stored in the ROM 42 into the RAM 43 and executes the program to perform the above-described various calculations.

The free space detection device 102 may be implemented by a field programmable gate array (FPGA) which is a rewritable logic circuit, or an application specific integrated circuit (ASIC), instead of a combination of the CPU 41, the ROM 42, and the RAM 43. The free space detection device 102 may be implemented by a combination of different configurations, for example, a combination of the CPU 41, the ROM 42, the RAM 43, and the FPGA, instead of the combination of the CPU 41, the ROM 42, and the RAM 43.

According to the first embodiment described above, the following effects are obtained.
(1) The free space detection device 102 arranges free space end points, which are determined based on objects detected around a predetermined center point such as the center of the vehicle 101, on 10 reference lines radially extending from the center point, for example, on the straight line L101 in FIG. 6, and connects the free space end points on the respective reference lines to extract an outer edge of a free space. When a boundary line is set between adjacent reference lines, one of the reference lines is set as a first reference line (L101 in FIG. 6), two of the boundary lines (L102 and L103 in FIG. 6) sandwiching the first reference line are set as first boundary lines, and a region (hatched region in FIG. 6) sandwiched by the first boundary lines with the first reference line as the center is referred to as a first angle region, the normalization unit 202 determines a position of the free space end point (star mark in FIG. 6) on the first reference line based on a position closest to the center point among in-region detection points (“C” to “E” surrounded by circles) which are the detection points present in the first angle region. Therefore, as described with reference to FIG. 6, the method according to the present embodiment can set a free space with higher accuracy than that in the comparative example.
(2) The normalization unit 202 includes the end point attribute assignment unit 2021 that sets an attribute for the free space end point based on an object detection state. Therefore, free space information can be used more appropriately.
(3) The normalization unit 202 includes the line attribute assignment unit 2022 that assigns an attribute to a line connecting the free space end points based on the attributes assigned to the free space end points. Therefore, the free space information can be used more appropriately.

### (Modification 1)

An output of the camera sensor 105 may not match a representation of a processing result of step S302. For example, the output of the camera sensor 105 may be a coordinate system other than the orthogonal coordinate system or an orthogonal coordinate system in which the original point and the axis do not match, and in this case, the normalization unit 202 performs coordinate conversion in step S302. The case where the original point does not match is, for example, a case where a coordinate system of the camera sensor 105 has an attachment position of the camera sensor 105 as the original point. The output of the camera sensor 105 may be a combination of a center position and a size of each obstacle, and in this case, an outer peripheral position of the obstacle is calculated in step S302.

Further, in step detection correction may be performed based on a posture of the host vehicle 101 such as roll or pitch associated with acceleration and deceleration of the host vehicle 101. A movement of the vehicle 101 due to a time difference between a detection time and a processing time may be reflected in the output of the camera sensor 105, or accuracy and reliability of a detection position may be improved by using statistical processing represented by a Kalman Filter.

### Second Embodiment

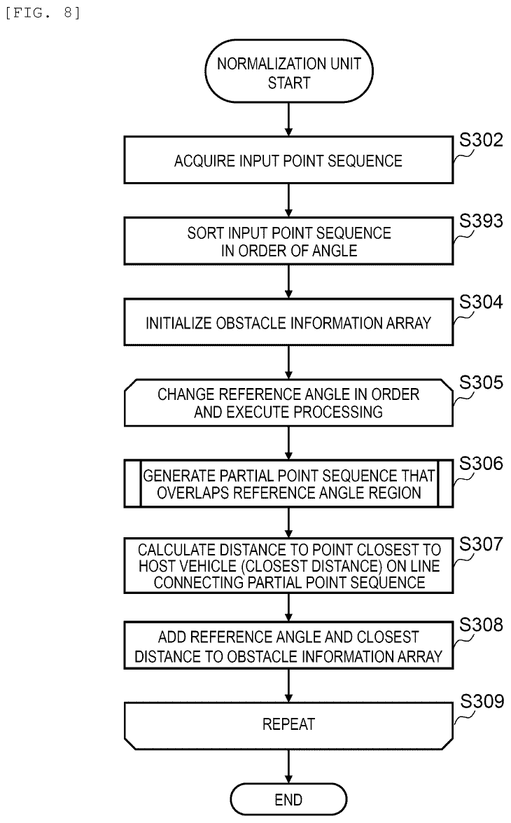

A second embodiment of the free space detection device will be described with reference to FIGS. 8 to 14. In the following description, the same components as those of the first embodiment are denoted by the same reference numerals, and differences between the second embodiment and the first embodiment will be mainly described. Points not particularly described are the same as those in the first embodiment. The present embodiment is different from the first embodiment mainly in that information on detection points in adjacent reference angle regions is also used.

FIG. 8 is a flowchart showing processing of the normalization unit 202 according to the second embodiment. The same processing as that in the flowchart shown in FIG. 3 according to the first embodiment are denoted by the same step number, and description thereof is omitted. The processing in the first step S302 is the same as that in FIG. 3. In step S393 executed after step S302, the normalization unit 202 sorts the input point sequence in the order of angle. An angle representation may be obtained by using the atan2 function, or, for example, a sin value and a cos value may be obtained by using a Euclidean distance to coordinates of a point and coordinate values, and only a magnitude relationship of angles may be obtained by using positive and negative coordinate values. In the latter case, a processing time required for the atan2 function can be saved. Since the sorting in step S393 is performed for reducing a processing load in step S306 to be described later, step S393 may be deleted and the processing in step S306 may be increased.

The normalization unit 202 executes step S304 after step S393. The processing in step S304 is the same as that in FIG. 3. In subsequent step S305, the normalization unit 202 changes reference angles to be processed in order and repeats the processing in steps S306 to S308. Specifically, the normalization unit 202 calculates all reference angles, stores the calculated reference angles in an array in an ascending order, and increases array indexes in order to change processing targets in order. In the present embodiment, a processing range of the input point sequence is limited by setting the reference angles in an ascending order to save processing, but the processing may be simplified without setting the reference angles in the ascending order. In addition, since the reference angle and the reference line have a correspondence relationship of 1:1, it can be said that the reference lines to be processed are changed in order and the processing in steps S306 to S308 are repeated.

In step S306, the normalization unit 202 executes processing of generating a partial point sequence that overlaps a reference angle region at a reference angle to be processed. An outline of the processing in this step will be described later in detail with reference to FIG. 5. In step S307, the normalization unit 202 calculates a closest distance which is a distance to a point closest to the host vehicle 101 on a line connecting the partial point sequence generated in step S306. The line connecting the partial point sequence is a line obtained by connecting points constituting the partial point sequence in the order of the point sequence. When a partial point sequence is not defined, a value indicating that the closest distance is not obtained, for example, a negative value is set.

In subsequent step S308, the normalization unit 202 adds a combination of the reference angle targeted in step S305 and the closest distance obtained in step S307 to the obstacle information array initialized in step S304. This is information indicating a free space end point on a reference line. When a value indicating that the closest distance is not obtained in step S307 is set, the information is converted into information indicating that there is no obstacle in step S308, and then the information is added to the obstacle information array. In step S309, the normalization unit 202 changes the processing target and returns the processing to step S306 when it is determined that there is an unprocessed reference angle, and ends the processing shown in FIG. 8 when the processing in steps S306 to S308 are executed for all reference angles to be processed.

### (Details of Partial Point Sequence Generation Processing)

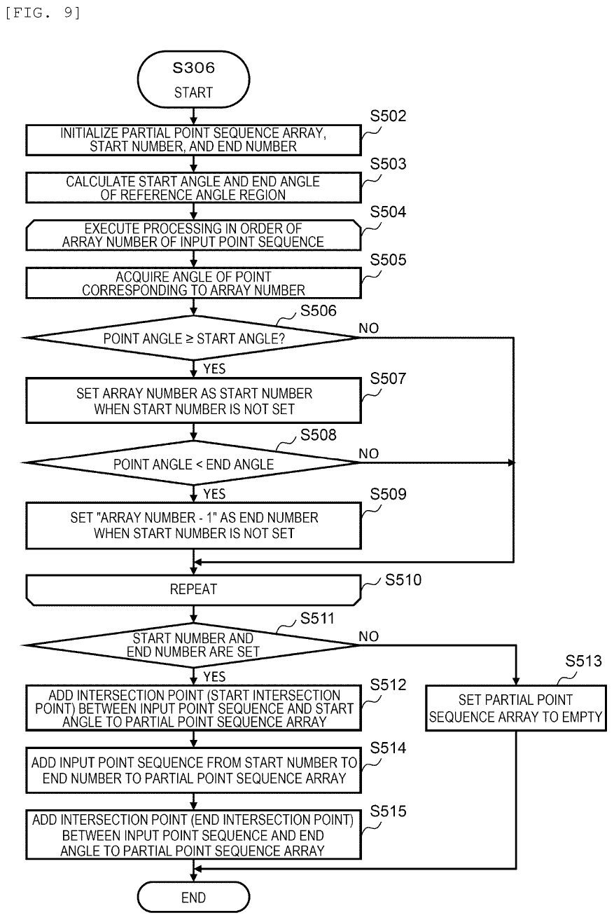

FIG. 9 is a flowchart showing details of the partial point sequence generation processing in step S306 shown in FIG. 8. Hereinafter, a specific example of the processing shown in FIG. 5 will be described. Before the processing shown in FIG. 9 is started, a reference angle to be processed, in other words, a reference line to be processed is set in step S305. In a range shown in FIG. 9, since the reference angle or the reference line to be processed does not change, the reference angle region does not change.

First in step S502, the normalization unit 202 initializes a partial point sequence array, a start number, and an end number. Elements of the partial point sequence array have the same format as the input point sequence, and at least have coordinate values of a point. The partial point sequence array is set to a coordinate value indicating that a point is invalid by initialization, for example, a huge value. The number of array elements may be made variable to save memory required for the array, and in this case, the number of elements may be set to “0” during initialization. The start number and the end number store array numbers of an input point sequence in subsequent processing. Therefore, the start number and the end number are set to values indicating that a number is not an array number, such as a negative value by initialization.

In subsequent step S503, the normalization unit 202 calculates a reference angle region. Specifically, the normalization unit 202 calculates a start angle and an end angle of the reference angle region. For example, when the step angle is “0.1 degrees” and the reference angle to be processed is “30 degrees”, the start angle is 29.95 degrees and the end angle is 30.05 degrees. As described above, the reference angle region is a region centered on a reference line. In step S504, the normalization unit 202 starts a loop in which an input point sequence array number increases in order from “0”. Specifically, the normalization unit 202 repeats the processing in steps S505 to S509 while increasing the array number to be processed by “1”.

In step S505, the normalization unit 202 acquires an angle of an input point corresponding to an array number to be processed. A representation of the angle may be a value obtained by atan2 or a pair of sin and cos values as described above as long as the start angle and the end angle can be compared with the angle. In subsequent step S506, the normalization unit 202 determines whether the angle of the input point acquired in step S505 is equal to or larger than an angle of a start point calculated in step S503. The normalization unit 202 proceeds the processing to step S507 when it is determined that the angle of the input point is equal to or larger than the angle of the start point, and proceeds the processing to step S510 when it is determined that the angle of the input point is less than the angle of the start point.

In step S507, the normalization unit 202 sets the array number to be processed as the start number when the start number initialized in step S502 remains initialized, that is, when the start number is not set, and proceeds the processing to step S508. When the start number is not set, the normalization unit 202 proceeds to step S508 without doing anything. In step S508, the normalization unit 202 determines whether the angle of the point acquired in step S505 is smaller than the end angle calculated in step S503. The normalization unit 202 proceeds the processing to step S509 when it is determined that the angle of the point acquired in step S505 is smaller than the end angle calculated in step S503, and proceeds the processing to step S510 when it is determined that the angle of the point acquired in step S505 is equal to or larger than the end angle calculated in step S503.

In step S509, the normalization unit 202 sets a value obtained by subtracting E from the array number to be processed as the end number when the end number initialized in step S502 remains initialized, that is, when the end number is not set, and proceeds the processing to step S510. When the end number is not set, the normalization unit 202 proceeds the processing to step S510 without doing anything. In step S510, when the array number to be processed is the last one in the input point sequence, the normalization unit 202 proceeds the processing to step S511, and when the array number to be processed is not the last one in the input point sequence, the normalization unit 202 sets the array number to be processed to a next array number in the input point sequence and returns the processing to step S505. In angle comparison in step S506 or step S508, the comparison is performed using a value obtained by adding 360 degrees to an angle or a value obtained by subtracting 360 degrees from the angle so that an absolute value of an angle difference is 180 degrees or less. This is to prevent a magnitude relationship from being reversed when crossing over 0 degrees or 360 degrees.

In step S511, the normalization unit 202 determines whether values are set for both the start number and the end number. When it is determined that values are set for both the start number and the end number, the processing proceeds to step S512, and when it is determined that at least one of the start number and the end number is not set, the processing proceeds to step S513. Whether the start number is set is synonymous with whether step S507 is executed. When step S507 or step S509 is not executed because, for example, none of the points included in the input point sequence is present in the reference angle region, a negative determination is made in step S511.

In step S512, the normalization unit 202 adds an intersection point between a line connecting the input point sequence and the start angle (hereinafter, referred to as a “start intersection point”) to the head of the partial point sequence array initialized in step S502, and proceeds the processing to step S514. Here, the start intersection point is an intersection point between a line connecting points of the input point sequence in order and a half straight line extending from the center of the host vehicle 101 in a direction of the start angle calculated in step S503. When there is no start intersection point, the normalization unit 202 does not add a start intersection point to the partial point sequence array in the processing in step S512.

In step S514, the normalization unit 202 adds an input point sequence indicated by array numbers from the start number to the end number including the start number and the end number to the end of the partial point sequence array initialized in step S502. In subsequent step S515, the normalization unit 202 adds an intersection point between the input point sequence and the end angle (hereinafter, referred to as an “end intersection point”) to the partial point sequence array, and ends the processing shown in FIG. 9. The end intersection point is an intersection point of a line connecting points included in the input point sequence in order and a half straight line extending from the host vehicle in a direction of the end angle calculated in step S503. When there is no end intersection point, the normalization unit 202 does not add an intersection point to the partial point sequence array in step S515.

In step S513 that is executed when a negative determination is made in step S511, the normalization unit 202 does not add anything to the partial point sequence array, leaves the partial point sequence array empty, and ends the processing shown in FIG. 9. The processing shown in FIG. 9 described above aims to generate the partial point sequence array initialized in step S502, and processing in and after step S307 shown in FIG. 8 is executed using the partial point sequence array.

### (Specific Example of Partial Point Sequence Generation Processing)

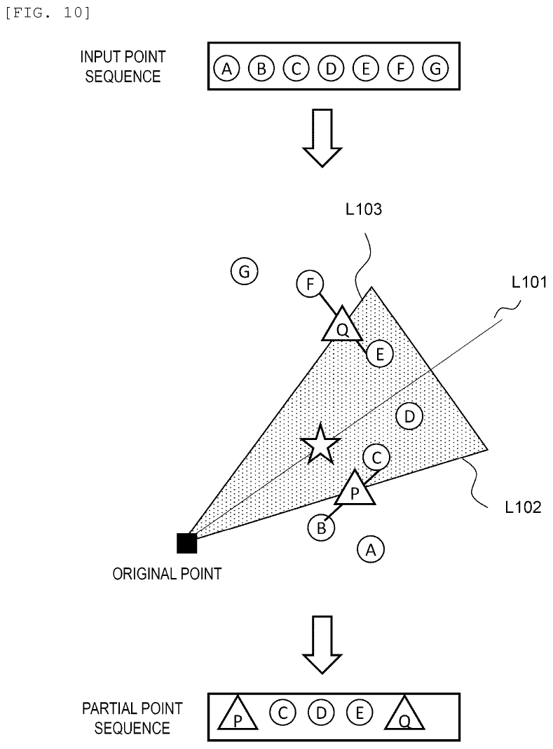

FIG. 10 is a view showing a specific example of the processing shown in FIG. 9. As shown in an upper part of FIG. 10, in the present example, seven points are stored in order from “A” surrounded by a circle to “G” surrounded by a circle in an input point sequence. In step S503, the normalization unit 202 calculates L102 indicating the start angle and L103 indicating the end angle. A region indicated by dot hatching and sandwiched between the straight line L102 and the straight line L103 is a reference angle region. A position of the input point sequence, “P” and “Q” each surrounded by a triangle, and a star mark shown in FIG. 10 are shown for the sake of convenience, and such information is not obtained when step S503 is completed. Specifically, the reference angle region includes “C” to “E” each surrounded by a circle.

As described above, steps S504 to S510 are repeatedly executed by the number of input point sequences. Hereinafter, the number of times of repeated processing is represented as a “loop”. For example, in a first loop, an input point sequence to be processed is “A” surrounded by a circle, and since the input point sequence has a total of “7” elements, processing is performed up to a seventh loop in the present example.

In the first loop, the normalization unit 202 sets “A” surrounded by a circle as a processing target, makes a negative determination in step S506, and ends the processing. In the second loop, the normalization unit 202 sets “B” surrounded by a circle as a processing target, and makes a negative determination in step S506 and ends the processing in a similar manner to the first loop. In the third loop, the normalization unit 202 makes a positive determination in step S506 because “C” surrounded by a circle, which is a processing target, is included in the reference angle region, and proceeds the processing to step S507. In step S507, the normalization unit 202 executes the third loop for the first time, and stores an array number “3” in the start number. In the subsequent step S508, the normalization unit 202 makes a negative determination since the processing target “c” is present on the right side of the straight line L103 in the drawing, and ends the processing.

In the fourth loop and the fifth loop, the normalization unit 202 sets “D” and “E” each surrounded by a circle as processing targets, and makes a positive determination in step S506, but since the execution of step S507 is not the first time, no particular processing is performed. In step S508, the normalization unit 202 makes a negative determination and ends the processing. In the sixth loop, the normalization unit 202 makes a positive determination in step S506, but since the execution of step S507 is not the first time, no particular processing is performed. In step S508, the normalization unit 202 makes a positive determination and proceeds the processing to step S509. In step S509, the normalization unit 202 sets “5” obtained by subtracting “1” from the element number “6” to the end number since step S509 is executed for the first time in the sixth loop, and ends the processing.

In the seventh loop, the normalization unit 202 sets “F” surrounded by a circle as a processing target, and makes a positive determination in both step S506 and step S508. However, the normalization unit 202 ends the processing without executing specific processing since neither step S507 nor step S509 is executed for the first time. When the processing of the seventh loop ends, the processing in steps S504 to S510 ends. In subsequent step S511, the normalization unit 202 makes a positive determination since both the start number and the end number are set, and proceeds the processing to step S512.

In step S512, the normalization unit 202 calculates the start intersection point which is an intersection point between a line connecting points of the input point sequence in order and a half straight line extending from the center of the host vehicle 101 in a direction of the start angle calculated in step S503. In the present example, since L102 indicating the start angle passes between “B” and “C” each surrounded by a circle, and the normalization unit 202 calculates coordinates of “P” surrounded by a triangle, which is an intersection point between a line connecting “B” and “C” each surrounded by a circle and the straight line L102. The normalization unit 202 adds “P” surrounded by a triangle to the partial point sequence. In step S514, the normalization unit 202 adds the elements “C” to “E” each surrounded by a circle, which are elements of the input point sequence from the start number “3” to the end number “5”, to the partial point sequence.

In step S515, the normalization unit 202 calculates the start intersection point which is an intersection point between a line connecting points of the input point sequence in order and a half straight line extending from the center of the host vehicle 101 in a direction of the end angle calculated in step S503. In the present example, since L103 indicating the end angle passes between “E” and “F” each surrounded by a circle, the normalization unit 202 calculates coordinates of “Q” surrounded by a triangle, which is an intersection point between a line connecting “E” and “F” each surrounded by a circle and the straight line L103. The normalization unit 202 adds “Q” surrounded by a triangle to the partial point sequence. Through the processing described above, the partial point sequence is calculated as “P” surrounded by a triangle, “C”, “D”, and “E” each surrounded by a circle, and “Q” surrounded by a triangle. The above is a specific example of the processing shown in FIG. 9.

When such a partial point sequence is obtained, a distance of “P” surrounded by a triangle that is the closest to the original point in the partial point sequence is calculated as the closest distance by the processing in step S307 and step S308 in FIG. 8. Therefore, the free space end point in the reference angle region shown in FIG. 10 is set at a position on a reference line L101 separated from the original point by the same distance from the original point to “P” surrounded by a triangle, that is, a position of a star mark.

### (Effects)

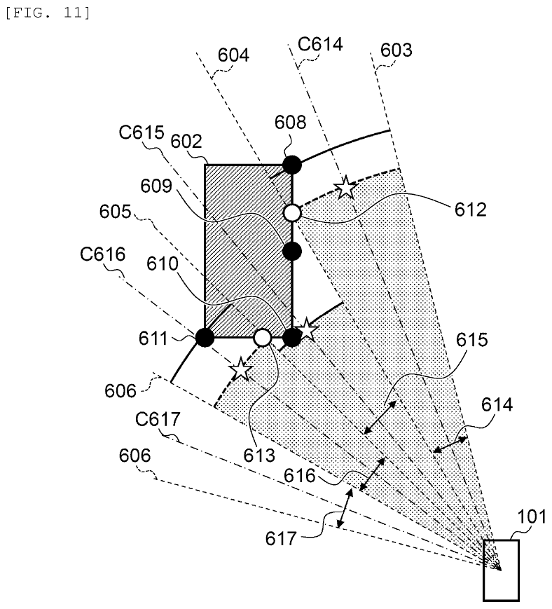

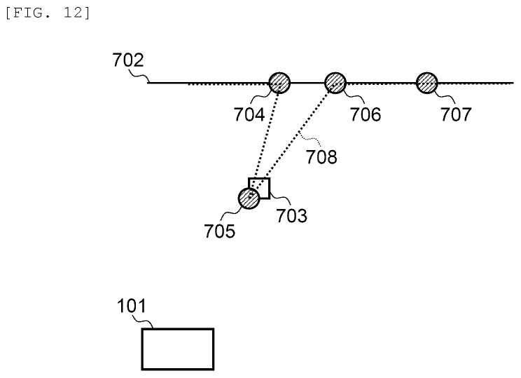

The method for converting to a common format according to the present embodiment, a conversion method according to the first embodiment, and a method for converting to a common format according to a second comparative example which is a second comparative example method will be compared with reference to FIG. 11 and FIGS. 12 to 14. The conversion method according to the first embodiment is compared with the conversion method according to the present embodiment in FIG. 11, and the second comparative example method is compared with the conversion method according to the present embodiment in FIGS. 12 to 14.

FIG. 11 is a diagram showing a comparison between the method for converting to the common format according to the present embodiment and the conversion method according to the first embodiment. The configuration shown in FIG. 11 is the same as that in FIG. 5 in the first embodiment, and thus description of repeated configuration is omitted. The conversion method according to the first embodiment uses the closest detection point in the reference angle region. A white star present on each reference line represents a free space end point. A white circle will be described later. According to the method in the first embodiment, when converting to the common format which is a free space by using the detection points 608 to 611 as the input point sequence, an outer edge of a free space region is set at a position indicated by an arc of a solid line as described with reference to FIG. 5.

On the other hand, when the method according to the present embodiment is used, points 612 and 613 each indicated by a white circle are obtained in the process of calculating the partial point sequence. As points closest to the host vehicle in the detection point sequence of the point sequence 608 to 611 indicating that the obstacle 602 is detected, a distance to the point 612 in the region 614, a distance to the point 610 in the region 615, and a distance to the point 613 in the region 616 are set as the closest distances, and there is no detection point in the region 617. In FIG. 11, an outer edge of a free space region obtained by the method according to the present embodiment is indicated by an arc of a broken line. In the region 615, the outer edge of the free space region according to the method in the first embodiment overlaps the outer edge of the free space region according to the method in the present embodiment. It can also be said that the free space end point indicated by a white star according to the present embodiment is moved on an arc centered on the original point and is arranged at a position intersecting the reference line, the arc being points closest to the original point in a partial point sequence in the respective reference angle regions.

When the method according to the first embodiment is compared with the method according to the present embodiment, the method according to the first embodiment uses a distance from the original point to an actually detected detection point as the closest distance, and emphasizes reliability of the detection point. On the other hand, in the method of the second embodiment, it is assumed that an obstacle is also present at positions in addition to the detection points, and a distance to the intersection point between the reference line and the center line is also used as a candidate of the closest distance by interpolating between detection points. There is no superiority or inferiority between the method according to the first embodiment and the method according to the second embodiment, but the way of considering a detection point detected by a sensor is different.

Next, the method for converting to the common format according to the present embodiment and the second comparative example method are compared with reference to FIGS. 12, 13, and 14. The second comparative example method is a method for converting to the common format by simply obtaining an intersection point between a detection point sequence and each reference angle by linear interpolation. FIG. 12 is a diagram showing an obstacle and detection points before conversion to a common format. In FIG. 12, the host vehicle 101 is present in a lower part of the drawing, and an obstacle 702 and an obstacle 703 are detected by a sensor. Detection results of the sensor are detection points 704, 705, 706, and 707, and a point sequence 708 connecting these detection points is used as an input point sequence. The obstacle 702 is an obstacle having a size at which a plurality of detection points are detected, such as a side wall, and the obstacle 703 is a small obstacle for which there is only one detection point, such as a pole.

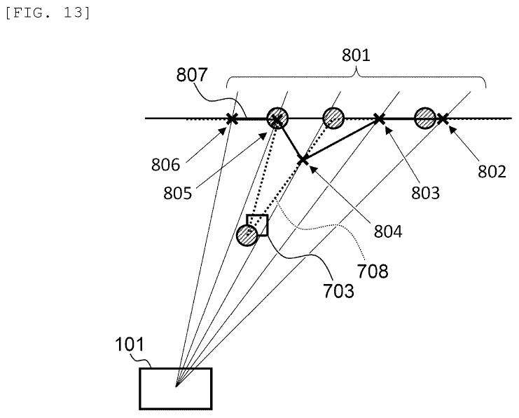

FIG. 13 is a view showing a result obtained by converting the detection result shown in FIG. 12 by the second comparative example method. In the second comparative example method, conversion to the common format is performed using linear interpolation. In FIG. 13, half straight lines 801 extending radially from the host vehicle 101 represents reference lines. For the input point sequence 708, points 802, 803, 804, 805, and 806 are obtained by linearly interpolating intersection points with the reference lines 801, and a point sequence 807 is formed.

In the point sequence 807, right and left sides of the obstacle 703 are points 804 and 805. Therefore, it is represented that a free space is present far from the position where the obstacle 703 is actually present, and the presence of the obstacle 703 is not sufficiently reflected in the point sequence 807. In other words, a free space is represented in which the presence of the obstacle 703 is overlooked. This is because each detection point of the detection point sequence 708 is present between the half straight lines of the reference lines 801.

When a driving action is planned based on the free space in a state in which the obstacle 703 is overlooked, there is a possibility that a plan to collide with the obstacle 703 is determined, which increases the risk of collision. Normalization by the linear interpolation is an excellent method for calculating a distance at each reference angle since the method has little computation, but it is understood that the presence of obstacles may be overlooked and distances to the obstacles cannot be accurately obtained.

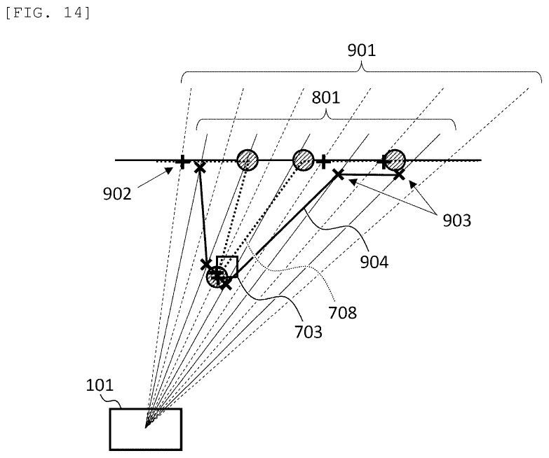

FIG. 14 is a diagram showing a result obtained by converting the detection result shown in FIG. 12 by the method according to the present embodiment. In FIG. 14, center lines 901 indicated by broken lines are obtained for the reference lines 801 indicated by solid lines. That is, each region between the center lines 901 is a reference angle region. A partial point sequence overlapping the detection point sequence 708 in each reference region is obtained, and a point 902 closest to the host vehicle on a line of the partial point sequence is indicated by a cross, that is, a plus marker. There is at most one point 902 in each reference angle region. A distance from the host vehicle 101 to the point 902 is set as a distance to an obstacle on each reference line 801, a point 903 is set to a distance set from the host vehicle 101 on each reference line, and a point sequence connecting the points 903 is shown as a point sequence 904. Looking at the point sequence 904, it can be seen that the points 903 are set at positions closer to the obstacle 703 than the point sequence in FIG. 13, and that a free space capturing the obstacle 703 can be represented more precisely.

According to the second embodiment described above, the following effects are obtained.
(4) The free space detection device 102 determines a position of a free space end point (the star mark in FIG. 11) on the first reference line based on a position closest to the center point among positions of in-region detection points (“C” to “E” each surrounded by a circle) which are detection points present in the first angle region and intersection points (“P” and “Q” each surrounded by a triangle) at which a straight line connecting the in-region detection points and a detection point not included in the first angle region intersects the first boundary line. Therefore, as described with reference to FIGS. 12 to 14, the method according to the present embodiment can set the free space with high accuracy.

### Third Embodiment

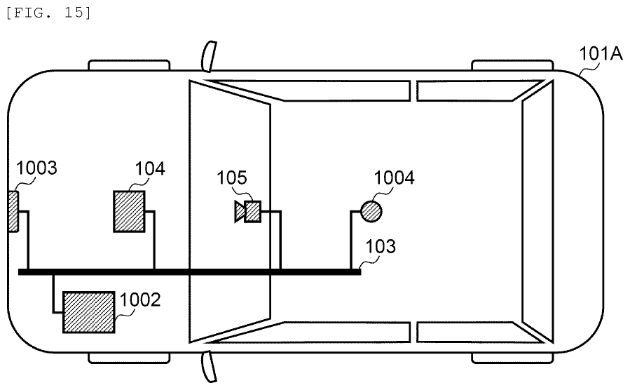

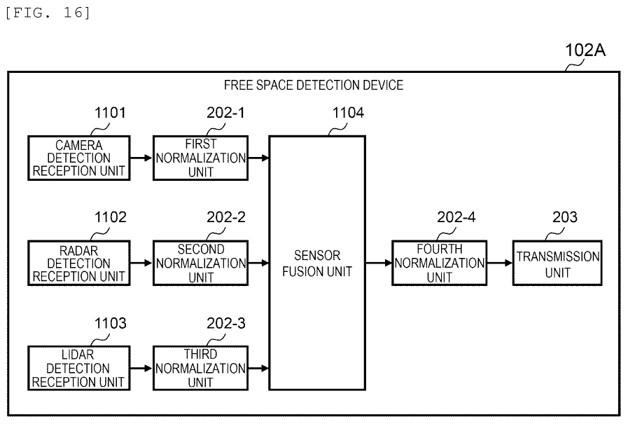

A third embodiment of the free space detection device will be described with reference to FIGS. 15 and 16. In the following description, the same components as those of the first embodiment are denoted by the same reference numerals, and differences between the third embodiment and the first embodiment will be mainly described. Points not particularly described are the same as those in the first embodiment. The present embodiment differs from the first embodiment mainly in that a plurality of sensors are mounted on a vehicle.

FIG. 15 is a hardware structure diagram showing a vehicle 101A equipped with a free space detection device 102A. The vehicle 101A includes the camera sensor 105, the common bus 103, and the driving action planning device 104 in a similar manner to the vehicle 101 in the first embodiment. The vehicle 101A further includes a radar sensor 1003 and a LIDAR 1004, and includes the free space detection device 102A instead of the free space detection device 102. The free space detection device 102A has the same hardware structure as the free space detection device 102 in the first embodiment.

In FIG. 15, all the sensors are connected by the common bus 103, and a connection form is not limited as long as detection results of the sensors can be transmitted to the free space detection device 102A. For example, the camera sensor 105, the radar sensor 1003, and the LIDAR 1004 may transmit detection results to the free space detection device 102A using different communication paths or communication protocols. Examples of the sensors include low voltage differential signaling (LVDS), CAN, and IEEE 802.3. By adopting such a configuration, it is possible to reduce development costs of sensors by adopting a communication method suitable for the sensors, and reduce a communication disconnection risk due to a failure of the common bus 103.

The free space detection device 102A combines detection results of the plurality of sensors into one piece of free space information and transmits the free space information to the driving action planning device 104. The present embodiment has advantages of increasing sensors to enhance fault tolerance, allowing sensors having different detection principles and detection ranges to complement one another to obtain the free space information in a wider range, and obtaining more reliable free space information.

FIG. 16 is a functional block diagram showing the free space detection device 102A. The free space detection device 102 includes a camera detection reception unit 1101, a radar detection reception unit 1102, a LIDAR detection reception unit 1103, a sensor fusion unit 1104, a first normalization unit 202-1, a second normalization unit 202-2, a third normalization unit 202-3, a fourth normalization unit 202-4, and the transmission unit 203. The camera detection reception unit 1101, the radar detection reception unit 1102, and the LIDAR detection reception unit 1103 have the same function as the reception unit 201 shown in FIG. 1. The camera detection reception unit 1101, the radar detection reception unit 1102, and the LIDAR detection reception unit 1103 receive respective obstacle information detected by the camera sensor 105, the radar sensor 1003, and the LIDAR 1004, and output an input point sequence to the corresponding normalization unit 202.

The first normalization unit 202-1, the second normalization unit 202-2, and the third normalization unit 202-3 execute the same processing as the normalization unit 202 in the first embodiment. The first normalization unit 202-1, the second normalization unit 202-2, and the third normalization unit 202-3 are different only in data to be processed, and there is no particular difference in operation. The first normalization unit 202-1, the second normalization unit 202-2, and the third normalization unit 202-3 convert obstacle information to a common format which is a free space, that is, execute normalization processing, and output the free space to the sensor fusion unit 1104. At this time, the free space information output by each normalization unit 202 may not match the original point.

The sensor fusion unit 1104 acquires the free space information output from the first normalization unit 202-1, the second normalization unit 202-2, and the third normalization unit 202-3, converts the free space information into values of a unified original point, for example, a coordinate system centered on the host vehicle 101A, and rearranges the values at angles viewed from the original point. A method for integrating three pieces of the free space information is not limited thereto. For example, after the three pieces of free space information are rearranged to have a unified original point, a plurality of points present within a predetermined distance from one another may be aggregated at the center of gravity position to reduce the number of points. Alternatively, as is common in a technique called sensor fusion, points of different free spaces may be tracked using a Kalman filter or the like, and may be combined into a more probable point to increase reliability of point positions.

The fourth normalization unit 202-4 executes the same processing as the normalization unit 202 in the first embodiment using obstacle information input from the sensor fusion unit 1104 as an input point sequence, converts the input point sequence into a free space of a common format, and outputs the free space to the transmission unit 203. The transmission unit 203 transmits free space information transmitted from the fourth normalization unit 202-4 to the transmission unit 203.

In the present embodiment, the normalization unit 202 is provided at both of an input and an output of the sensor fusion unit 1104, thereby eliminating the need to be aware of a difference in an output format of a detection result of a sensor. Further, since a mechanism for guaranteeing an output matching the common format is not required during processing, processing of the sensor fusion unit 1104 can be simplified.

### Modification of Third Embodiment

In the third embodiment described above, the normalization unit 202 is provided at both the input and the output of the sensor fusion unit 1104. Alternatively, in order to reduce a processing load, the normalization unit 202 on the input side of the sensor fusion unit 1104 may be omitted and only the normalization unit 202 on the output side of the sensor fusion unit 1104 may be provided, or the normalization unit 202 on the output side of the sensor fusion unit 1104 may be omitted. When the normalization unit 202 on the input side of the sensor fusion unit 1104 is omitted, the sensor fusion unit 1104 needs to deal with detection results of different formats for each sensor. When the normalization unit 202 on the output side of the sensor fusion unit 1104 is omitted, the sensor fusion unit 1104 needs to execute processing of converting the free space output by the sensor fusion unit 1104 to a common format.

### Fourth Embodiment

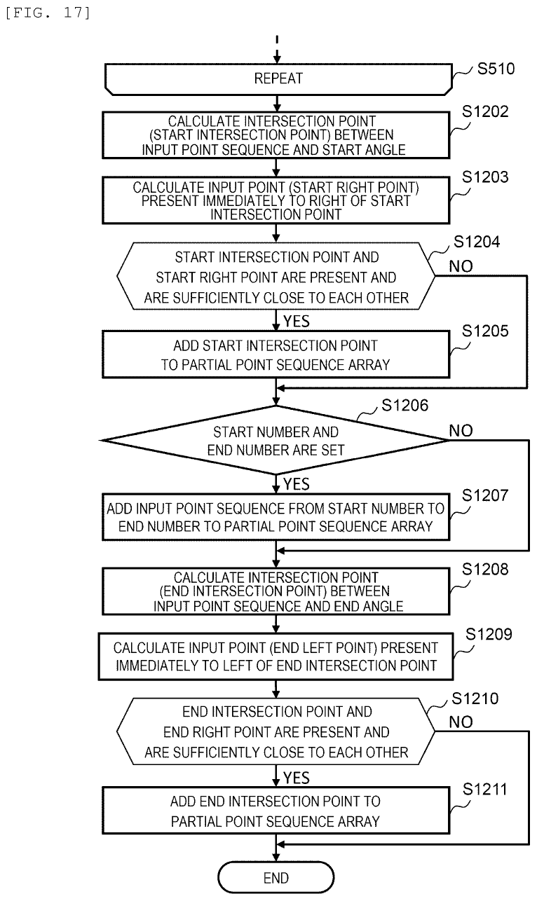

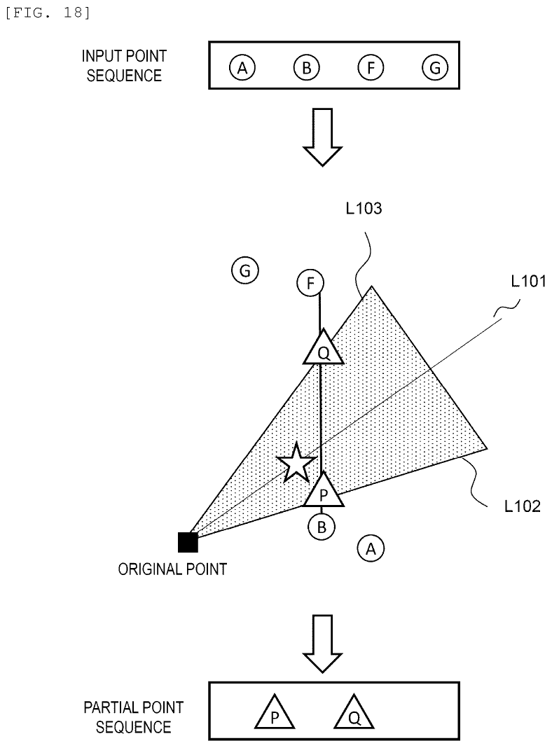

A fourth embodiment of the free space detection device will be described with reference to FIGS. 17 to 18. In the following description, the same components as those of the second embodiment are denoted by the same reference numerals, and differences between the fourth embodiment and the second embodiment will be mainly described. Points not particularly described are the same as those in the second embodiment. In the present embodiment, an operation of the normalization unit 202 is different from that in the second embodiment. Other configurations and operations are the same as those in the second embodiment, and thus description thereof is omitted.

FIG. 17 is a flowchart showing processing of the normalization unit 202 according to the fourth embodiment. The flowchart shown in FIG. 17 corresponds to step S511 and subsequent steps in FIG. 5 in the second embodiment. That is, the entire processing shown in FIG. 8 in the second embodiment and the processing in steps S502 to S510 in FIG. 9 are the same as those in the first embodiment. When the loop processing shown in steps S504 to S510 is completed, the normalization unit 202 executes step S1202.

In step S1202, the normalization unit 202 calculates the start intersection point in the same manner as in the processing in step S512 in the first embodiment. As described in the first embodiment, the start intersection point may be not present. In subsequent step S1203, the normalization unit 202 calculates an input point (hereinafter, referred to as a “start right point”) that is present immediately to the right of the start intersection point when the start intersection point is present, and does not do anything when the start intersection point is not present. The start right point is a point whose angle is closest to the start intersection point among input points present on a right side of the start intersection point when viewed from the host vehicle 101. However, depending on values of an input point sequence, there may be no start right point.

In step S1204, the normalization unit 202 determines whether both the start intersection point and the start right point are present and the start intersection point and the start right point are sufficiently close to each other. The definition of being sufficiently close will be described later. When the normalization unit 202 determines that both the start intersection point and the start right point are present and the start intersection point and the start right point are sufficiently close to each other, the normalization unit 202 proceeds the processing to step S1205, and when the normalization unit 202 determines that any one of the start intersection point and the start right point is not present or the start intersection point and the start right point are not sufficiently close to each other, the normalization unit 202 proceeds the processing to step S1206. In step S1205, the normalization unit 202 adds the start intersection point to the partial point sequence array initialized in step S502, and proceeds the processing to step S1206.

In step S1206, the normalization unit 202 determines whether both the start number and the end number are set as in step S511 in the first embodiment. The normalization unit 202 determines that both the start number and the end number are set, the normalization unit 202 proceeds the processing to step S1207, and when the normalization unit 202 determines that at least one of the start number and the end number is not set, the normalization unit 202 proceeds the processing to step S12008. In step S1207, the normalization unit 202 adds an input point sequence from the start number to the end number to the partial point sequence array as in step S514 in the first embodiment, and proceeds the processing to step S1208.

In step S1208, the normalization unit 202 calculates an end intersection point as in step S515 in the first embodiment. As described in the first embodiment, the end intersection point may be not present. In subsequent step S1209, the normalization unit 202 calculates an input point (hereinafter, referred to as an “end left point”) present immediately to the left of the end intersection point when the end intersection point is present, and does not do anything when the end intersection point is not present. The end left point is a point whose angle is closest to the end intersection point among input points present on a left side of the end intersection point as viewed from the host vehicle 101, and there may be no end right point depending on values of the input point sequence.

In subsequent step S1210, the normalization unit 202 determines whether the end intersection point and the end left point are present and the end intersection point and the end left point are sufficiently close to each other. When it is determined that both the end intersection point and the end left point are present and the end intersection point and the end left point are sufficiently close to each other, the normalization unit 202 proceeds the processing to step S1211, and when it is determined that any one of the end intersection point or the end left point is not present or the end intersection point and the end left point are not sufficiently close to each other, the processing in FIG. 17 ends. In step S1211, the normalization unit 202 adds the end intersection point to the partial point sequence array, and ends the processing in FIG. 17.

Note that “sufficiently close” in step S1204 and step S1210 refers to that a distance between two points is less than a predetermined value such as 1 m. The definition of “sufficiently close” may be another definition. For example, when a distance between two points is less than 0.1 m, the distance may be defined as “sufficiently close”. In this case, a risk of erroneous interpolation to a position where there is no obstacle is reduced. “Sufficiently close” may be defined as a difference between angles of two points being less than a predetermined threshold. In this case, a risk of erroneous interpolation is reduced. By adopting the present embodiment, even when an input point is not included in a reference angle region, a free space end point can be interpolated as long as a condition of step S1204 or step S1208 is satisfied. Therefore, for example, even when obstacle detection by a sensor is rougher than a common format, a free space can be generated by interpolating an obstacle position.

FIG. 18 is a view showing a specific example of the processing of the normalization unit 202 according to the present embodiment. FIG. 18 shows calculation of a free space end point in a reference angle region centered on the reference line L101 under substantially the same precondition as that in FIG. 10 in the second embodiment. Different from FIG. 10, the number of points in the input point sequence is small, and “A”, “B”, “F”, and “G” each surrounded by a circle are used. Therefore, there is no input point sequence in a reference angle region indicated by hatching. In the present embodiment, “P” surrounded by a triangle which is a start intersection point is calculated in step S1202, and “Q” surrounded by a triangle which is an end intersection point is calculated in step S1208. Therefore, when a positive determination is made in all of step S1204, step S1206, and step S1210, “P” and “Q” each surrounded by a triangle are set as a partial point sequence.

Then, by the processing in step S307 and step S308 in FIG. 8, a distance between the original point and “P” surrounded by a triangle, “P” surrounded by a triangle being closer to the original point between “P” and “Q” each surrounded by a triangle, is added to the obstacle information array as the closest distance. Therefore, in the example shown in FIG. 15, a distance from the free space end point indicated by a white star on the reference line L101 to the original point is equal to the distance from “P” surrounded by a triangle to the original point.

According to the fourth embodiment described above, the following effects are obtained.
(5) When there is no object presence point in the first reference angle region, the normalization unit 202 sets a free space end point based on a position of an intersection point between the first boundary line and a line connecting a pair of object presence points present on both sides of the first reference angle region. Therefore, a free space end point can be formed even when there is no input point sequence in the reference angle region.

### Modification of Fourth Embodiment

In the present embodiment, step S511 and subsequent steps in FIG. 9 are replaced with processing from step S1201 to step S1211. Alternatively, step S511 may remain and step S512 and subsequent steps may be replaced with processing from step S1201 to step S1211. In this case, when there is no start number or end number, step S513 is executed, and when there is no input point sequence in the reference angle region, no partial point sequence is generated, and a risk of excessively interpolating a free space end point in the present embodiment can be reduced.

In the embodiments described above, a vehicle on which the free space detection device is mounted is assumed to be a four-wheel vehicle. Alternatively, the free space detection device may be mounted on a vehicle other than a four-wheel vehicle. For example, the free space detection device may be mounted on a movable vehicle such as a two-wheel vehicle, a bus, a truck, a three-wheel vehicle, a cart, a tracked vehicle, or a rail vehicle. The free space detection device may not be mounted on a moving object. For example, the free space detection device may be installed in a warehouse where a cart moves, and the free space detection device may process information of a sensor installed in a warehouse. In this case, the degree of freedom in installing the sensor can be increased.

When the free space detection device processes outputs of a plurality of sensors as in the second embodiment, the plurality of sensors are provided to compensate for blind spots, thereby improving detection reliability. Alternatively, a plurality of free space detection devices may be communicably connected and used, and free space information output by a free space detection device may be used by another free space detection device. Further, in this case, the free space detection device may output not only free space information but also an output of a sensor to another free space detection device, and the free space detection device can generate free space information using information of a sensor connected to another free space detection device. When the free space information is output to another device, by performing normalization described in the present embodiment, it is not necessary to consider an output format of each sensor, and the design of a monitoring device can be simplified.

In the embodiments and modifications described above, a configuration of a functional block is merely an example. Some functional configurations shown as separate functional blocks may be integrated, or a configuration shown in one functional block diagram may be divided into two or more functions. Further, some of the functions of each functional block may be provided in another functional block.

Although a program is stored in the ROM 42 (not shown) in the embodiments and modifications described above, the program may be stored in a nonvolatile storage device. The free space detection device may include an input and output interface (not shown), and a program may be read from another device via a medium that can be used by the input and output interface and the free space detection device when necessary. Here, the medium refers to, for example, a storage medium detachable from the input and output interface, or a communication medium, that is, a network such as a wired, wireless, or optical network, or a carrier wave or a digital signal spreading through the network. Some or all of the functions implemented by the program may be implemented by a hardware circuit or an FPGA.

The embodiments and modifications described above may be combined with one another. Although various embodiments and modifications have been described above, the invention is not limited to the contents thereof. Other aspects conceivable within the scope of the technical idea of the invention are also included within the scope of the invention.

### REFERENCE SIGNS LIST

102, 102A: free space detection device
201: reception unit
202: normalization unit
2021: end point attribute assignment unit
2022: line attribute assignment unit

1. A free space detection device that arranges free space end points, which are determined based on detection points of objects detected around a predetermined center point, on a plurality of reference lines radially extending from the center point, and that extracts an outer edge of a free space by connecting the free space end points on the plurality of reference lines, wherein
a boundary line is set between the reference lines adjacent to each other; and
when one of the reference lines is referred to as a first reference line, two of the boundary lines sandwiching the first reference line are referred to as first boundary lines, and a region sandwiched between the first boundary lines with the first reference line being a center is referred to as a first angle region, a position of the free space end point on the first reference line is determined based on a position closest to the center point among in-region detection points which are the detection points present in the first angle region.

2. The free space detection device according to claim 1, wherein
the position of the free space end point on the first reference line is determined based on a position closest to the center point among positions of the in-region detection points and a position of an intersection point where the first boundary line intersects a straight line connecting the in-region detection point and the detection point not included in the first angle region.

3. The free space detection device according to claim 2, wherein
when the detection point is not present in the first angle region, the free space end point is set based on a position of the intersection point with a line connecting a pair of the detection points present on both sides of the first angle region.

4. The free space detection device according to claim 1, further comprising:
an end point attribute assignment unit configured to set an attribute for the free space end point based on a detection state of the object.

5. The free space detection device according to claim 4, further comprising:
a line attribute assignment unit configured to assign an attribute to a line connecting the free space end points based on the attribute assigned to the free space end points.

6. An object position normalization method executed by a free space detection device that arranges free space end points, which are determined based on detection points of objects detected around a predetermined center point, on a plurality of reference lines radially extending from the center point, and that extracts an outer edge of a free space by connecting the free space end points on the plurality of reference lines, the object position normalization method comprising:
when a boundary line between the reference lines adjacent to each other is set, one of the reference lines is referred to as a first reference line, two of the boundary lines sandwiching the first reference line are referred to as first boundary lines, and a region sandwiched between the first boundary lines with the first reference line being a center is referred to as a first angle region,
determining a position of the free space end point on the first reference line based on a position closest to the center point among in-region detection points which are the detection points present in the first angle region.
